(19) United States
(12) Patent Application Publication
(10) Pub. No.: US 2014/0300520 A1
(43) Pub. Date: Oct. 9, 2014

(54) FULL-SPACE SCANNING END-SWITCHED CRLH LEAKY-WAVE ANTENNA

(71) Applicants: Van-Hoang Nguyen, Montreal (CA); Samer Abielmona, Ottawa (CA); Christophe Caloz, Montreal (CA)

(72) Inventors: Van-Hoang Nguyen, Montreal (CA); Samer Abielmona, Ottawa (CA); Christophe Caloz, Montreal (CA)

(73) Assignee: Polyvalor, Limited Partnership, Montreal (CA)

(21) Appl. No.: 14/110,201

(22) PCT Filed: Apr. 5, 2012
(86) PCT No.: PCT/CA12/00343

§ 371 Date: Jun. 25, 2014

Related U.S. Application Data
(60) Provisional application No. 61/472,849, filed on Apr. 7, 2011.

(51) Int. Cl. H01Q 13/20; H01Q 3/00

(52) U.S. Cl. CPC H01Q 13/206; H01Q 3/00
USPC 343/739

(57) ABSTRACT

The present relates to a leaky-wave antenna unit. The leaky wave antenna unit comprises a leaky wave antenna having two ports and a switching unit. The switching unit comprises an input, two throws and an actuator. The input of the switching unit receives a signal to be radiated by the leaky wave antenna. Each of the throw is connected to a different port of the leaky wave antenna, while the actuator switches the input between the two throws.

### FIELD

The present invention relates to the field of wireless communication, and more particularly to a full-space scanning end-switched Composite Right/Left-Handed Leaky-Wave Antenna.

### BACKGROUND

Planar leaky-wave antennas (LWAs) have garnered interest recently due to their ability to efficiently scan the full-space as described in the following publications and incorporated therein: C. Caloz, D. R. Jackson, and T. Itoh, Frontiers in Antennas: Next Generation Design and Engineering, Chap. 9: Leaky-Wave Antennas, F. B. Gross (ed.), McGraw Hill, 2011; and S. Paulotto, P. Baccarelli, F. Frezza, and D. R. Jackson, “A novel technique for open-stopband suppression in 1-D periodic printed leaky-wave antennas,” IEEE Trans. Antennas Propagat., vol. 57, no. 7, pp. 1894-1906, July 2009.

One type of planar LWAs is the frequency scanned composite right/left-handed (CRLH) LWA, described in the following publications and incorporated therein: C. Caloz and T. Itoh, Electromagnetic metamaterials transmission line theory and microwave applications, Wiley and IEEE-Press, 2005; and C. Caloz, T. Itoh, and A. Rennings, “CRLH metamaterial leaky-wave and resonant antennas,” IEEE Antennas Propagat. Magazine, vol. 50, no. 5, pp. 25-39, Oct. 2008.

For single-frequency operation, the electronically-scanning LWA (eLWA), having no feeding network and low-cost varactors consuming no power, is a viable alternative to phased-array antennas which utilize expensive and power hungry phase shifters with bulky and lossy feeding networks. A schematic representation of the eLWA is shown on FIG. 9. The eLWA is well described in the following publication which is also incorporated herein: S. Lim, C. Caloz, and T. Itoh, “Metamaterial-based electronically controlled transmission line structure as a novel leaky-wave antenna with tunable angle and beamwidth,” IEEE Trans. Microwave Theory Tech., vol. 53, no. 1, pp. 161-173, Jan. 2005.

The conventional CRLH eLWA is excited at one port and is terminated at the other by a matched load. While it can achieve full-space steering from backfire to endfire, it suffers from several deficiencies.

First, the conventional CRLH eLWA design is quite complex since a large scanning range is required with good matching throughout. In turn, this requires high-performance varactors with high capacitance values and a large capacitance tuning range. These demanding varactor performance parameters make the varactors costly, and the varactors of limited commercial availability, as described in the following publications: R. Siragusa, H. V. Nguyen, C. Caloz, and S. Tedjini, “Efficient electronically scanned CRLH leaky-wave antenna using independent double tuning for impedance equalization,” in Proc. CNC/USNC URSI National Radio Science Meeting, San Diego, Calif., Jul. 2008; and D. Piazza, D'Amico Michele, and K. R. Dandekar, “Two port reconfigurable CRLH leaky wave antenna with improved impedance matching and beam tuning,” European Conference on Antennas and Propagation EuCAP 2009, pp. 2046-2049, Berlin, Germany, Mar. 2009.

Second, the CRLH eLWA antenna patterns are non-symmetrical with respect to broadside due to the uneven field distributions between the backward and forward modes of operation.

Third, a large scanning loss is exhibited when scanning the full-space due to the gain drop of the element factor near backfire and endfire, as explained in the following publication: R. J. Mailloux, Phased Array Antenna Handbook, Norwood Mass., Artech House, 1994.

Finally, reverse-biased varactors suffer from inherent loss due to the voltage modulation of the P-N junction (P-type and N-type regions of a semiconductor specimen), with high loss at high capacitance values, degrading the antenna's efficiency.

For all those reasons, there is a need for a full-space scanning end-switched Composite Right/Left-Handed Leaky-Wave Antenna which addresses these problems in order to make the antenna more commercially viable.

### SUMMARY

The present relates to a leaky-wave antenna unit. The leaky wave antenna unit comprises a leaky wave antenna having two ports, and a switching unit. The switching unit comprises an input, two throws and an actuator. The input receives a signal to be radiated by the leaky wave antenna. Each of the throws is connected to a different port of the leaky wave antenna. The actuator switches the input between the two throws.

### DESCRIPTION OF THE DRAWINGS

FIG. 1 shows a schematic block diagram of the present Leaky Wave Antenna.

FIG. 2 shows an equivalent circuit model for a CRLH eLWA unit cell showing: (a) Varactor circuit model showing Cvar(V), Rvar(V) and a package parasitic Lp=0.5 nH and Cp=0.1 pF; and (b) Varactor's measured (solid line) and circuit model (dashed line) results for S11 and S21 at V=2 V and V=20 V.

FIG. 3 is a picture of an End-switched CRLH LWA prototype where: (a) depicts a top layer with a close-up view of the radiative region for a single unit cell; and (b) depicts a bottom layer with a close-up view of the RF switch.

FIG. 4 is a graph showing measured return loss (S11) for several radiation angles (θ=0°; ±20°; ±60°. At fₒ=2.45 GHz, S11 is less than −10 dB for all scan angles, indicating good matching throughout the full-space. In addition, the end-switched CRLH eLWA's symmetry can be observed where, for each angle, the return loss is similar for both switch states.

FIG. 5 is a graph showing measured radiation patterns at fₒ=2.45 GHz. The beam is steered in the backward region only from)(−60≦θ≦0°) in the left and right quadrant when S1/S2 are set to ON/OFF and OFF/ON, respectively. Thus, with only half-space beam-scanning, the entire full-space is scanned, and the achieved gain variation is ±1.5 dB in the full-space scanning range.

FIG. 6 are graphs showing measured capacitance (Cvar), resistance (Rvar), and voltage (V) for the varactors utilized in the CRLH eLWA (Markers: measured values; solid line: interpolated values). The reduction in range for all three parameters for the end-switched CRLH eLWA case versus the conventional one is also shown. (a) Series varactor Var_se. (b) Shunt varactor Var_sh.

FIG. 7 are graphs presenting the antenna pattern (element pattern x array factor) results for the conventional full-space scanning CRLH eLWA (element pattern centered θ=0°) (the left graph), and the end-switched half-space scanning CRLH eLWAs (element pattern centered θ=30°) (the right graph).

FIG. 8 is a graph showing the efficiency for the end-switched half-space scanning and conventional full-space scanning CRLH eLWA.

FIG. 9 is a schematic representation of a conventional CRLH eLWA.

FIG. 10 is a schematic representation of another embodiment of end-switched CRLH eLWA, including a rat race coupler.

### DETAILED DESCRIPTION

The foregoing and other features of the present end-switched CRLH eLWA will become more apparent upon reading of the following non-restrictive description of examples of implementation thereof, given by way of illustration only with reference to the accompanying drawings.

In the present description, the expression end-switched eLWA is used to refer to the presently claimed leaky wave antenna unit. Thus the expression end-switched eLWA should not be construed as the only possible implementation of the present leaky wave antenna, but rather as an exemplary implementation thereof.

The present description relates to an end-switched eLWA where the input signal is routed to either port of the CRLH eLWA via a switch. Each port provides half-space scanning)(−90°≦θ≦0°) and thus the full-space (−90°≦θ≦90°) is scanned via the switching mechanism. This scheme first overcomes the deficiencies of conventional CRLH eLWAs, hence enhancing performance, and second may be applied to any two-port LWA (with and without electronic-steering capabilities) along with other novel performance improvement schemes.

Examples of LWAs with two-port electronic steering capabilities are described in the following publication, which is incorporated by reference herein: N. Yang, C. Caloz, and K. Wu, “Full-space scanning periodic phasereversal leaky-wave antenna,” IEEE Trans. Microwave Theory Tech., vol. 58, no. 10, pp. 2619-2632, Oct. 2010.

More information on improvement schemes are provided in the following publications, also incorporated herein by reference: H. V. Nguyen, S. Abielmona, and C. Caloz, “Highly efficient leakywave antenna array using a power-recycling series feeding work,” IEEE Antennas Wireless Propagat. Lett., vol. 8, pp. 441-444, Mar. 2009; and H. V. Nguyen, A. Parsa, and C. Caloz, “Power-recycling feedback system for maximization of leaky-wave antennas radiation efficiency,” IEEE Trans. Microwave Theory Tech., vol. 58, no. 7, pp. 1641-1650, July 2010.

### Proposed End-Switched CRLH ELWA

### Principle of Operation

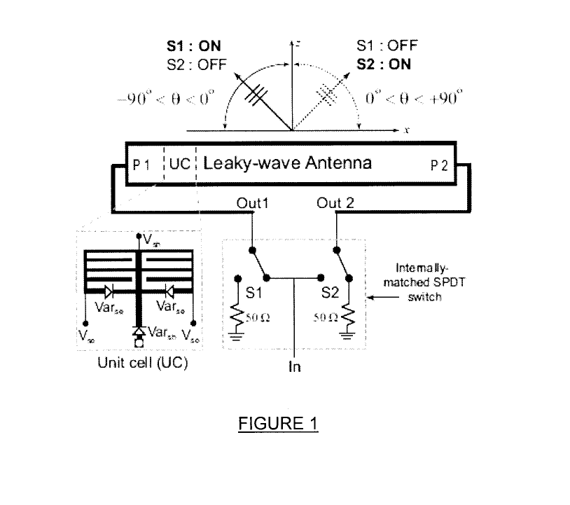

FIG. 1 schematically illustrates the principle of operation of the present leaky wave antenna unit for performing symmetric full-space scanning with a CRLH eLWA. A leaky wave antenna, shown here as a two-port (P1 and P2) CRLH eLWA, is connected to a switching unit, i.e. single pole double-throw (SPDT) switch, which routes the signal to either port while internally terminating the other with 50Ω. The SPDT switch could be internally-matched, as shown in FIG. 1, or externally matched, whichever embodiment is the most convenient from a design and/or performance purposes.

The CRLH eLWA is composed of several unit cells (UCs), each encompassing in series an inter-digital capacitor in parallel with a varactor and in shunt a stub inductor in series with a varactor as shown in the exploded view of the UC of FIG. 1. A resulting radiated beam is steered by independently tuning both voltages Vse and Vsh shown in the exploded view of the UC in FIG. 1, while maintaining good matching, as described in the following publication incorporated by reference herein: R. Siragusa, H. V. Nguyen, C. Caloz, and S. Tedjini, “Efficient electronically scanned CRLH leaky-wave antenna using independent double tuning for impedance equalization,” in Proc. CNC/USNC URSI National Radio Science Meeting, San Diego, Calif., Jul. 2008.

The CRLH eLWA of FIG. 1 may thus operate in a backward mode or a forward mode from either P1 or P2. In the backward mode, the generated beam backwardly scans, i.e., from −90°≦θ≦0° in a left quadrant and +90°≦θ≦0° in a right quadrant for P1 and P2, respectively, as shown in FIG. 1. In contrast, in the forward mode, the generated beam forwardly scans, i.e., from +90°≦θ≦0° in a right quadrant and −90°≦θ≦0° in a left quadrant for P1 and P2, respectively, as shown in FIG. 1.

The CRLH eLWA of FIG. 1 is configured to operate in the backward mode. As shown in FIG. 1, when switch 1 (S1) is ON and switch 2 (S2) is OFF, an input signal is routed to P1, where a resulting generated beam is backwardly scanned from)(−90°≦θ≦0°) in the left quadrant. Conversely, when S1 is OFF and S2 is ON, the input signal is routed to P2, and the beam is also backwardly scanned but in the right quadrant.

The present end-switched CRLH eLWA reduces the angular scanning range from 180° to 90°. As a result, an antenna design is simplified since first, a smaller capacitance tuning range is required, relaxing the varactor's constraints and lowering cost; second, matching is now maintained over a smaller frequency range. In addition, symmetrical beam patterns are automatically obtained around broadside (θ=0°). Furthermore, a scanning loss is greatly reduced since the scanning range varies from θ=−90° to 0° (S1-ON/S2-OFF state) and θ=0° to +90° (S1-OFF/S2-ON state) instead of θ=−90° to +90°. And finally, the antenna efficiency is enhanced due to the reduction of the varactor's losses as a result of a lower capacitance tuning range.

### Exemplary Design Guidelines

The present design guidelines begin by establishing the antenna's specifications: fₒ, scan range, and unit cell size.

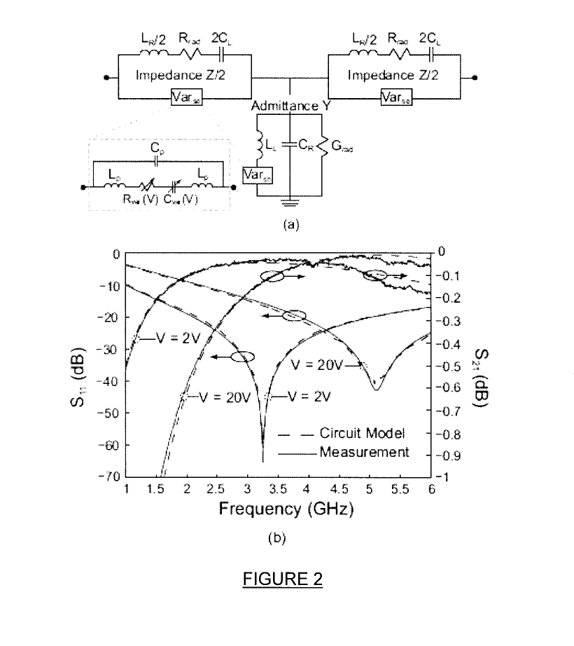

1) Obtain a dispersion relation β(Z;Y) and Bloch impedance ZB(Z; Y) for the unit cell of FIG. 2(a), as described in the following publication incorporated herein by reference: Caloz and T. Itoh, Electromagnetic metamaterials transmission line theory and microwave applications, Wiley and IEEE-Press, 2005.

2) Solve for Z,Y from 1) and compute their values based on the design specifications.

3) Measure and model commercially-available varactors. A circuit model is shown in FIG. 2(a), and its values are obtained by curve-fitting TRL-calibrated measurements to a circuit model's results, to extract varactor's capacitance (Cᵥₐᵣ), resistance (Rᵥₐᵣ), and reverse-biased voltage. Varactor results are shown in FIG. 2(b).

4) Express Z,Y of 2) in terms of unit cell's circuit components (LR;CL;LL;CR).

5) Based on the results of 2) and 3), solve for LR;CL;LL;CR so that θ=(scan range)/2 at fₒ.

6) Synthesize LR;CL;LL;CR into an inter-digital capacitor and a shunt inductor using synthesis equations as described in the following publication: R. Siragusa, H. V. Nguyen, C. Caloz, and S. Tedjini, “Efficient electronically scanned CRLH leaky-wave antenna using independent double tuning for impedance equalization,” in Proc. CNC/USNC URSI National Radio Science Meeting, San Diego, Calif., Jul. 2008.

7) Using a full-wave electromagnetic simulation tool (HFSS), extract an equivalent circuit model values for the interdigital capacitor and shunt inductor using a method described in [12] K. Sakakibara, et. al. “A two-beam slotted leaky waveguide array mobile reception of dual-polarization DBS,” IEEE Trans. on Vehicular Technology, vol. 48, no. 1, Jan. 1999, pp. 1-7″, and compare with 5).

### Experimental Results

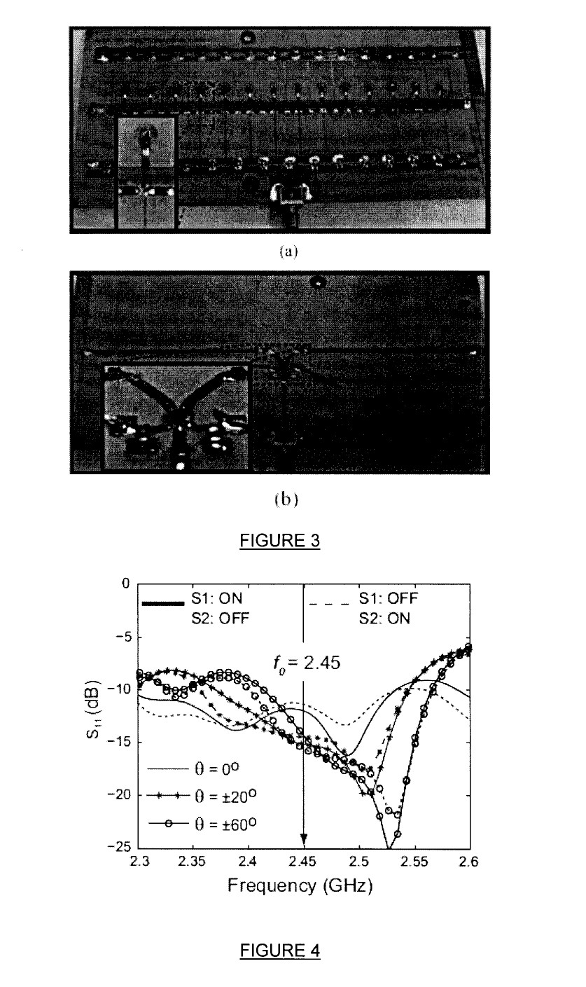

FIG. 3 shows respectively a top view (a) and a bottom view (b) of an end-switched CRLH eLWA prototype. The prototype is composed of two low-loss back-to-back PCBs (RO3003, εr=3, h=1.524 mm), with a common ground in the middle. The radiating CRLH eLWA is printed on the top PCB, shown in FIG. 3(a), while the switch and its connecting transmission lines are printed in the bottom PCB, shown in FIG. 3(b). The two layers are connected through a slot in their common ground by a transition formed by a row of three metalized vias, as taught and described in the following publication: F. P. Casares-Miranda, C. Viereck, C. Camacho-Penalosa, and C. Caloz, “Vertical microstrip transition for multilayer microwave circuits with decoupled passive and active layers,” IEEE Microwave Wireless Compon. Lett., vol. 16, no. 7, pp. 401-403, July 2006.

The CRLH eLWA is composed of 14 unit cells each with a size of 10 mm for a total size of 14 cm or 1.14λₒ at 2.45 GHz. The varactors are Aeroflex™ MSV 34.075 while the RF switch is CEL μPG2176T5N with a measured insertion loss of 0.7 dB.

FIG. 4 is a graph showing measured reflection coefficient's magnitude (S11) for several radiation angles for θ=0°, ±20°, ±60°. At fₒ=2.45 GHz, S11<−10 dB for all scan angles, indicating acceptable matching throughout the full-space. This graph also shows the inherent symmetry of the end-switched CRLH eLWA, where a return loss is similar for both switch states for each angle.

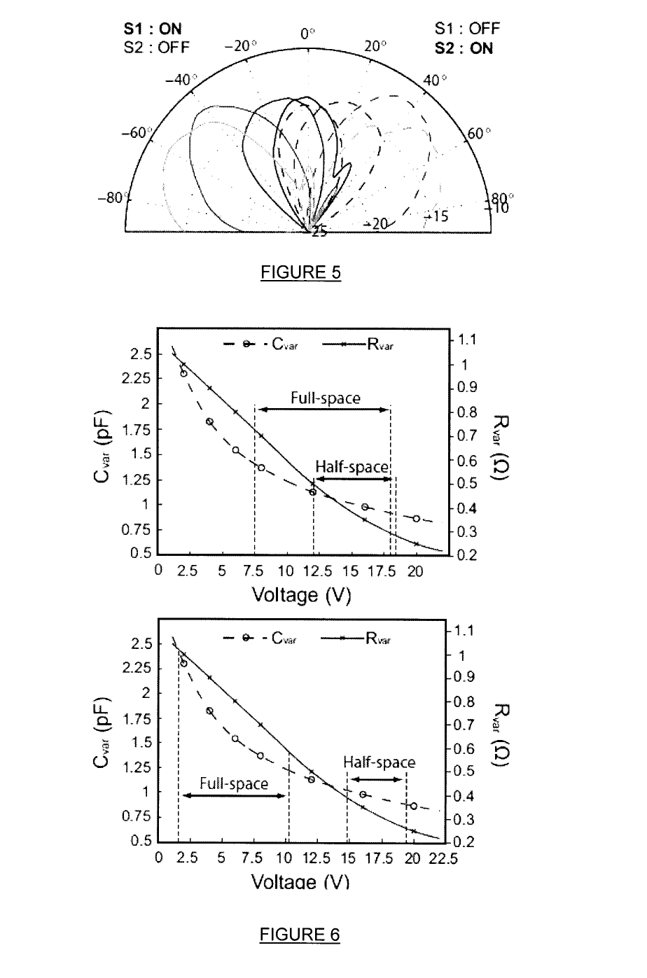

FIG. 5 is a graph showing measured radiation patterns at fₒ=2.45 GHz. A generated beam is steered in only the backward region from −60°≦θ≦0° in the left and right quadrants when S1/S2 are set to ON/OFF and OFF/ON, respectively. Thus, with only half-space beam-scanning, the entire full-space is scanned. A resulting gain variation is ±1.5 dB in the full-space scanning range.

### Results

Two CRLH eLWAs were theoretically designed, a conventional CRLH eLWAs and an end-switched CRLH eLWAs, to scan a 120° sector from θ=−60 to θ=+60. The design parameters and performances of both CRLH eLWAs were compared to highlight the benefits of the end-switched CRLH eLWA.

### Simplified Design

As previously described, because of its conception, the scanning range of the end-switched CRLH eLWA is reduced by half. This reduction of the scanning range by half relaxes the design constraints on the varactors of each unit cell by lowering their capacitance tuning range, while making the unit cell design simpler.

FIGS. 6(a) (top) and 6(b) (bottom) are graphs showing the varactor's measured capacitance (Cᵥₐᵣ), resistance (Rᵥₐᵣ), and reverse-biased voltage. As seen from FIGS. 6(a) and 6(b) for the series and shunt varactors (Vₐᵣₛₑ and Vₐᵣₛₕ of FIG. 1), respectively, a reduction in the range of all three varactor's parameters is observed for the end-switched CRLH eLWA compared to the conventional one. Table I summarizes the varactor's parameters.

TABLE I
CAPACITANCE, VOLTAGE, AND RESISTANCE RANGES
FOR THE SERIES AND SHUNT VARACTORS OF FIG. 1

| | Capacitance | | Resistance | | Voltage | |
|---|---|---|---|---|---|---|
| | range (pF) | | range (Ω) | | range (V) | |
| Steering mode | Cᵥₐᵣ₁ | Cᵥₐᵣ₂ | Rᵥₐᵣ₁ | Rᵥₐᵣ₂ | V₁ | V₂ |
| Full-space | 0.465 | 1.19 | 10.5 | 9.1 | 0.431 | 0.444 |
| Half-space | 0.22 | 0.13 | 6.5 | 4.24 | 0.218 | 0.121 |
| % Reduction | 53 | 89 | 38 | 53.4 | 49.4 | 72.7 |

### Pattern Symmetrization

FIG. 5 shows that the measured patterns are symmetrical with respect to the broadside radiation direction (θ=0°) due to the end-switching mechanism of the CRLH eLWA.

### Scanning Loss Reduction

An antenna pattern (element factor*array factor) is analytically computed for both the end-switched CRLH eLWA and the conventional CRLH eLWA, without considering any varactor loss (Rᵥₐᵣ=0). The antenna pattern is given by:

$$AP = EF \times {\sum }_{n = 1}^{N} {I}_{n} {e}^{j ( n - 1 ) {k}_{o} p ( sin θ - sin {θ}_{o} )} , \qquad ( 1 )$$

where EF=cos θ_{EF}, with θ_{EF} and θₒ being the element factor angle and array scanning angle, respectively. For the end-switched CRLH eLWA, θ_{EF}=30° and θ=−30°±30°, while for the conventional CRLH eLWA, θ_{EF}=0° and θ=0°±60°. More information on the relation EF=cos θ_{EF} may be obtained by the following publication enclosed by reference herein “D. Jackson, A. Oliner, Modern antenna handbook, Chap. 7: Leaky-wave antennas, C. Balanis (ed.), Wiley, 2008”.

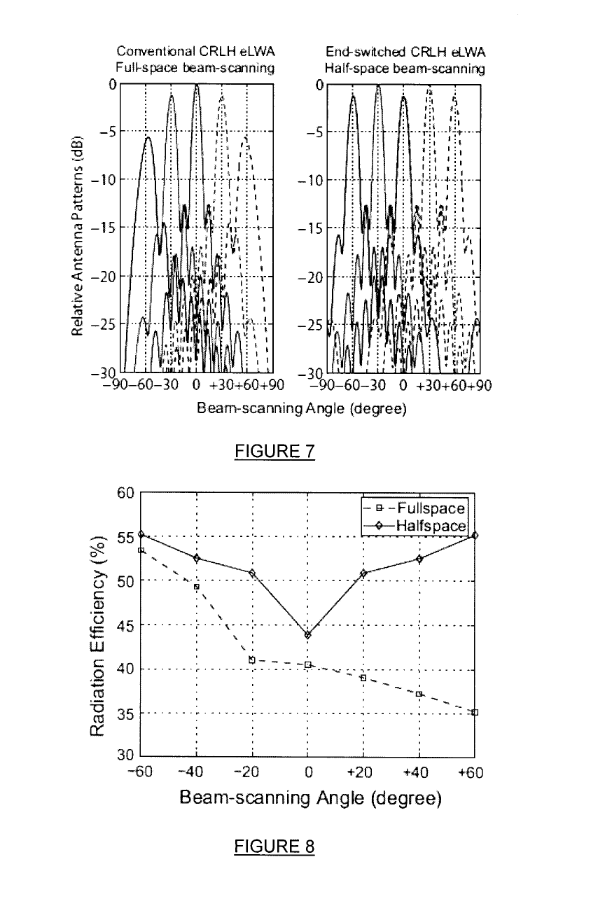

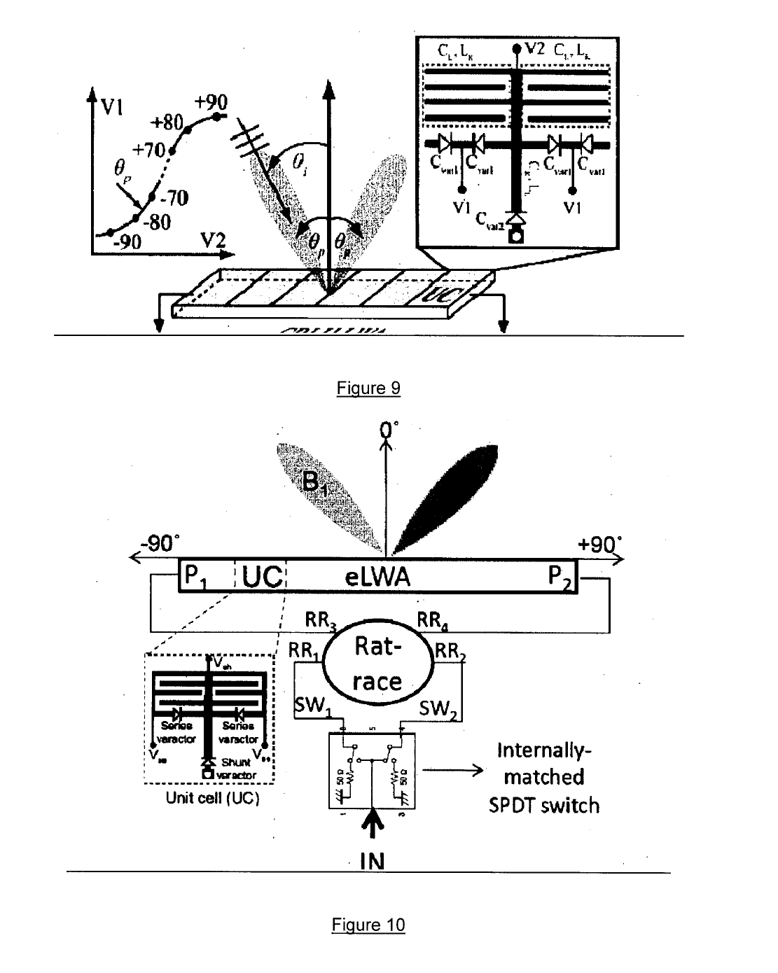

FIG. 7(a) (left) shows that the conventional CRLH eLWA exhibits a 5.5 dB scanning loss from θ=0°±60°, while FIG. 7(b) (right) shows that the end-switched CRLH eLWA exhibits only a 1 dB scanning loss from θ=−30°±30°.

### Enhanced Efficiency

Using the series and shunt varactor's extracted capacitance ranges shown in FIGS. 6(a) and 6(b) and the extracted radiation resistance (Rrad), the efficiency may be given by:

$$η = \frac{{P}_{rad}}{{P}_{rad} + {P}_{loss}} , \qquad ( 2 )$$

where P_{rad} and Pₗₒₛₛ equal 1−|S₁₁|²−|S₂₁|² computed from the circuit response of FIG. 2(a) with Rᵥₐᵣ=0 and R_{rad}=0, respectively.

FIG. 8 is a graph showing the efficiency for the end-switched CRLH eLWA and the conventional CRLH eLWA. As can be seen, the efficiency of the end-switched CRLH eLWA is symmetrical around broadside (θ=0°) due to the half-space scanning and disclosed end-switching scheme. In addition, the minimum efficiency is higher, from 35% at θ=+60 for the conventional CRLH eLWA to ˜45% at θ=0° for the end-switched CRLH eLWA. Finally, the worst efficiency increased from 35% at θ=+60° for the conventional CRLH eLWA to 55% at θ=60° for the end-switched CRLH eLWA.

### End-Switched CRLH eLWA With Rat Race Coupler

Referring now to FIG. 10, there is shown a schematic representation of another embodiment of end-switched CRLH eLWA, in which a rat race coupler (RR) is added. Thus to the embodiment described in FIG. 1, the RR is inserted between the two port eLWA and the SPDT. Again, as previously discussed, the SPDT could be internally matched, or externally matched depending on design preferences.

The RR is a four-port device that contains two pairs of symmetric input and output ports. For example, RR1 and RR4 may be input ports, while RR2 and RR3 are output ports, labeled the difference and sum ports, respectively. In another example, RR2 and RR3 may be input port, while RR1 and RR4 are output ports, labeled the difference and sum ports, respectively. Thus, although the following description uses RR1 and RR4 as input ports, the present end-switched CRLH eLWA is not limited to this combination, but to any symmetrical combination of ports of the RR.

When a continuous signal is fed at RR1, it then exits the RR at RR3 and enters the eLWA at P1, where part of the signal is radiated into free-space with the remaining non-radiated part exiting the eLWA at P2. The non-radiated signal then enters the RR at RR4, denoted as being “recycled”, and recombines in-phase (i.e., constructively) at RR3 with the signal from RR1. Part of the signal from RR4 is then re-radiated along with the continuous signal from RR1.

After a transient period of time, the end-switched CRLH eLWA with RR reaches a steady-state, where 100% of the input signal at RR1 being radiated, and achieving theoretically 100% radiation efficiency.

As the RR is a symmetrical device, a similar behaviour is exhibited if the input signal is fed at RR2.

Of course, to achieve efficient recycling of the non-radiated signal the output port of the eLWA, the RR must be selected so as to have specifications corresponding to those of the eLWA, i.e. similar wideband in-phase combining, and tunable in amplitude and phase for constructive interference. The latter items are not considered problematic and can be addressed using known circuit design techniques. The latter items are not considered problematic and can be addressed using known circuit design techniques.

Although a RR has been described herein and shown in FIG. 10, any other symmetric power-combining device can be used instead of the RR, thus transforming the end-switched CRLH eLWA into a highly efficient end-switched CRLH eLWA. More information on the power-recycling eLWA is found in international patent application number PCT/CA20101001947 incorporated by reference herein.

The overall benefit of the highly efficient end-switched CRLH eLWA presented in FIG. 2 is the improvement of the eLWA's radiation efficiency by addition of the RR.

Previous state-of-the-art eLWAs suffered from poor radiation efficiency unless their lengths were long. However, long eLWAs were impractical for commercial applications, and thus short eLWAs are usually employed. The present end-switched CRLH eLWA and highly efficient end-switched CRLH eLWA allow a short eLWA to be practically realizable, and in the case of the highly efficient end-switched CRLH eLWA to reach almost 100% radiation efficiency and thus very high gain.

The present end-switched CRLH eLWA and high efficiency end-switched CRLH eLWA can be used in any type of wireless communication, such as for example: a wireless base station, a wireless network node, a wireless device, a wireless Radio Frequency Identification unit or system, a wireless transmitter, a wireless system and/or a wireless network.

Although the present end-switched CRLH eLWA and highly efficient end-switched CRLH eLWA have been described in the foregoing description by way of illustrative embodiments thereof, these embodiments can be modified at will, within the scope of the appended claims without departing from the spirit and nature of the appended claims.

1. A leaky-wave antenna unit comprising:
a leaky wave antenna having two ports; and
a switching unit, the switching unit comprising an input, two throws and an actuator, the input receiving a signal to be radiated by the leaky wave antenna, each of the throw being connected to a different port of the leaky wave antenna, and the actuator switching the input between the two throws.

2. The leaky-wave antenna unit of claim 1, wherein the switching unit further comprises at least one internal load.

3. The leaky-wave antenna unit of claim 1, wherein each port of the leaky-wave antenna provides half-space scanning of the leaky wave antenna.

4. The leaky-wave antenna unit of claim 3, wherein the switching unit switches the input between the two throws, thereby achieving full-space scanning by the leaky wave antenna.

5. The leaky-wave antenna unit of claim 1 wherein the leaky-wave antenna is a composite right/left-handed leaky-wave antenna.

6. The leaky-wave antenna unit of claim 1, further comprising a power combining module, the power combining module being disposed between the leaky wave antenna and the switching unit so as to recycle non-radiated signal at an output port of the leaky-wave antenna with the signal to be radiated.

7. The leaky wave antenna unit of claim 6, wherein the power combining module is a rat race coupler.

8. The leaky wave antenna unit of claim 1, wherein the switching unit is an internally-matched single pole double throw switch.

9. Use of the leaky wave antenna unit of claim 1, in at least one of the following:
a wireless base station, a wireless network node, a wireless device, a wireless transmitter, a wireless system and/or a wireless network.
